(19) United States
(12) Patent Application Publication
(10) Pub. No.: US 2016/0197349 A1
(43) Pub. Date: Jul. 7, 2016

(54) ADDITIVES FOR IMPROVING THE IONIC CONDUCTIVITY OF LITHIUM-ION BATTERY ELECTRODES

(71) Applicant: ARKEMA FRANCE, Colombes (FR)

(72) Inventor: Grégory SCHMIDT, Mornant (FR)

(73) Assignee: ARKEMA FRANCE, Colombes, OT (FR)

(21) Appl. No.: 14/916,320

(22) PCT Filed: Jul. 17, 2014
(86) PCT No.: PCT/FR2014/051833

§ 371 Date: Mar. 3, 2016

(30) Foreign Application Priority Data
Sep. 5, 2013 (FR) 13.58485

(51) Int. Cl. H01M 4/62; H01M 4/04; H01M 4/525; H01M 10/0525; H01M 4/131; H01M 4/505

(52) U.S. Cl. CPC H01M 4/62; H01M 4/131; H01M 4/505; H01M 4/525; H01M 4/625; H01M 4/623; H01M 10/0525; H01M 4/0402

(57) ABSTRACT

An electrode material, preferably a positive electrode material, for a lithium-ion battery, to the method of preparing same, and to a lithium-ion battery incorporating said electrode material. This composite electrode material includes: an electronically conductive additive, such as carbon; an active material that is an oxide, a phosphate, a fluorophosphate or a silicate of lithium; a polymer binder such as PVDF; and an organic salt corresponding to defined chemical formulae, for example LiPDI, LiTDI, LiPDCI, LiDCTA, LiFSI, LiTFSI, optionally as a mixture. The organic salt makes it possible to increase the ionic conductivity of the electrode.

### FIELD OF THE INVENTION

The present invention relates generally to the field of electrical energy storage in lithium storage batteries of Li-ion type. More specifically, the invention relates to a Li-ion battery electrode material, to its method of preparation and to its use in a Li-ion battery. Another subject matter of the invention is the Li-ion batteries manufactured by incorporating this electrode material.

### TECHNICAL BACKGROUND

An elementary cell of a Li-ion storage battery or lithium battery comprises an anode (on discharging), generally made of lithium metal or based on carbon, and a cathode (likewise on discharging), generally made of a lithium insertion compound of metal oxide type, such as LiMn₂O₄, LiCoO₂ or LiNiO₂, between which is inserted an electrolyte which conducts lithium ions.

In the event of use, thus during the discharging of the battery, the lithium released by oxidation at the (−) pole by the anode in the ionic form Li⁺ migrates through the conducting electrolyte and will be inserted by a reduction reaction in the crystal lattice of the active material of the cathode (+) pole. The passage of each Li⁺ ion in the internal circuit of the battery is exactly compensated for by the passage of an electron in the external circuit, generating an electric current which can be used to supply various devices in the field of portable electronics, such as computers or telephones, or in the field of applications of greater power and energy density, such as electric vehicles.

During charging, electrochemical reactions are reversed, the lithium ions are released by oxidation at the (+) pole, “cathode” (the cathode on discharging becomes the anode on recharging), they migrate through the conductive electrolyte in the reverse direction from that in which they circulated during the discharging, and will be deposited or will be inserted by reduction at the (−) pole, “anode” (likewise, the anode on discharging becomes the cathode on recharging), where they may form dendrites of lithium metal, which are possible causes of short circuits.

A cathode or an anode generally comprises at least one current collector on which is deposited a composite material which consists of: one or more “active” materials, active because they exhibit an electrochemical activity with respect to lithium, one or more polymers which act as binder and which are generally functionalized or nonfunctionalized fluoropolymers, such as polyvinylidene fluoride, or aqueous-based polymers of carboxymethylcellulose type or styrene/butadiene latexes, plus one or more electron-conducting additives which are generally allotropic forms of carbon.

The conventional active materials at the negative electrode are generally lithium metal, graphite, silicon/carbon composites, silicon, fluorographites of CFₓ type with x between 0 and 1, and titanates of LiTi₅O₁₂ type.

The conventional active materials at the positive electrode are generally of the LiMO₂ type, of the LiMPO₄ type, of the Li₂MPO₃F type, of the Li₂MSiO₄ type, where M is Co, Ni, Mn, Fe or a combination of these, of the LiMn₂O₄ type or of the S₈ type.

Recently, additives which make it possible to improve the permeability of the electrolyte to the core of the electrode have been used. As a result of the growing demand for high-energy batteries, that is to say batteries with higher electric storage capacities, the thickness of the electrodes is increasing and thus the permeability of the electrolyte is becoming important in the overall resistance of the battery. With the aim of improving this permeability, the patent WO2005/011044 describes the addition of “inorganic” fillers of metal oxides, such as Al₂O₃ and SiO₂.

These inorganic fillers are added during the conventional process for the manufacture of electrodes. This conventional process consists in mixing the different constituents in a solvent or a mixture of solvents, such as, for example, N-methylpyrrolidone, acetone, water or ethylene carbonate:
a) at least one conducting additive at a content ranging from 1 to 5% by weight, preferably from 1.5 to 4% or 1 to 2.5% by weight, preferably from 1.5 to 2.2% by weight, with respect to the total weight of the composite material;
b) a lithium oxide, phosphate, fluorophosphate or silicate as electrode active material capable of reversibly forming an insertion compound with lithium, having an electrochemical potential greater than 2V with respect to the Li/Li⁺ pair;
c) a polymer binder.

The ink obtained is subsequently coated onto the current collector and the solvent or solvents are evaporated by heating ranging from 30 to 200° C.

The failings of these inorganic fillers are that they decrease the amount of active material in the electrode and thus the capacity of the battery but also these fillers only make it possible to improve the macroscopic diffusion of the electrolyte.

In point of fact, in the electrode, it is the charging resistance of the active material/electrolyte interface which is limiting for the performance of the battery. This resistance is a microscopic effect which cannot be improved by the addition of macroscopic inorganic filler.

The applicant has discovered that the addition of a salt consisting of an organic anion, chosen in order to have a favorable interaction at the surface of the active material, makes it possible to increase the ionic conductivity of the electrode.

### SUMMARY OF THE INVENTION

The invention relates first to the use of organic salts as ionic conductivity additives in the formulation of electrodes of Li-ion storage batteries, preferably in the cathode formulation. These salts can also be used in the formulation of electrodes of Na-ion batteries.

Another subject matter of the invention is the use of said formulation as battery electrode.

The ion-conducting additive has to be capable of withstanding the conditions of the process for the preparation of the electrodes described above. For example, LiPF₆, the lithium salt currently used in the majority of the electrolytes, due to its temperature instability and instability towards nucleophilic solvents, cannot be used as ionic conductivity additive.

The invention also relates to a Li-ion battery electrode composite material, preferably a positive electrode material, comprising:
a) at least one electron-conducting additive at a content ranging from 1 to 5% by weight, preferably from 1.5 to 4% or 1 to 2.5% by weight, preferably from 1.5 to 2.2% by weight, with respect to the total weight of the composite material;
b) a lithium oxide, phosphate, fluorophosphate or silicate as electrode active material capable of reversibly forming an insertion compound with lithium, having an electrochemical potential greater than 2V with respect to the Li/Li⁺ pair;
c) a polymer binder;
d) at least one organic salt of formula A and/or B:

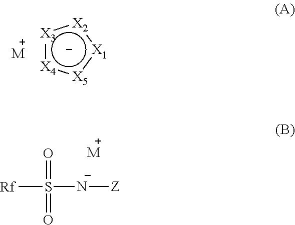

In the formula (A), —Xᵢ— independently represents the following groups or atoms: —N═, —N⁻—, —C(R)═, —C⁻(R)—, —O—, —S(═O)(R)═ or —S(R)═ and R represents a group chosen from F, CN, NO₂, S—CN, N═C═S, —OCₙHₘFₚ, —CₙHₘFₚ with n, m and p integers. The compounds of formula (A) which are particularly preferred are the imidazolates represented below and advantageously lithium imidazolates:

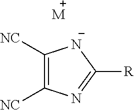

where R represents F or —CₙHₘFₚ. These lithium salts are particularly advantageous due to their insensitivity to water, which makes possible simplified use in the process for the preparation of the electrode.

In the formula (B), R_{f} represents F, CF₃, CHF₂, CH₂F, C₂HF₄, C₂H₂F₄, C₂H₃F₂, C₂F₅, C₃F₆, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃ and Z represents an electron-withdrawing group chosen from F, CN, SO₂R_{f}, CO₂R_{f} or COR_{f}.

In the general formulae above, M⁺ represents a lithium cation, a sodium cation, a quaternary ammonium or an imidazolium.

Preferably, the constituent (d) can vary between 0.01 and 10% and advantageously from 0.05 to 5% by weight, with respect to the total weight of the material.

The polymer binder is advantageously chosen from functionalized or nonfunctionalized fluoropolymers, such as polyvinylidene fluoride (PVDF) or aqueous-based polymers of carboxymethylcellulose type or styrene-butadiene latexes.

The electron-conducting additive is preferably chosen from the different allotropic forms of carbon or conducting organic polymers.

### Preparation of the Electrode

Another subject matter of the present invention is a process for the preparation of the electrode composite material described above, which comprises:
i) at least a stage of preparation of a suspension involving:
   one or more organic salts of formula A and/or B;
   an electron-conducting additive;
   a polymer binder;
   one or more volatile solvents;
   an electrode active material chosen from a lithium oxide, phosphate, fluorophosphate or silicate, and
ii) a stage of preparation of a film starting from the suspension prepared in (i).

The suspension can be obtained by dispersion and homogenization by any mechanical means, for example using a rotor-stator or an anchor stirrer or by ultrasound.

The suspension can be prepared from the polymer in the pure state or in the form of a solution in one or more volatile solvent(s), from the organic salts in the pure state or in the form of a suspension in one or more volatile solvent(s), from the electron-conducting additive and from the active material in the pure state, optionally after a stage of drying at a temperature of between 50 and 150° C.

Preferably, the volatile solvent(s) is or are chosen from an organic solvent or water. Mention may in particular be made, as an organic solvent, of the organic solvents N-methylpyrrolidone (NMP) or dimethyl sulfoxide (DMSO).

The suspension can be prepared in a single stage or in two or three successive stages. When the suspension is prepared in two successive stages, one embodiment consists in preparing, in the first stage, a dispersion containing the solvent, the organic salt(s) and optionally all or part of the polymer binder, using mechanical means, and then, in a second stage, adding the other constituents of the composite material to this first dispersion. The film is subsequently obtained from the suspension on conclusion of the second stage.

When the suspension is prepared in three successive stages, one embodiment consists in preparing, in the first stage, a dispersion containing the organic salt(s) and optionally all or part of the polymer binder in a solvent, and then, in a second stage, adding the active material and removing the solvent, in order to obtain a powder, and subsequently in adding solvent and the remainder of the constituents of the composite material, in order to obtain a suspension. The film is subsequently obtained from the suspension on conclusion of the third stage.

The dissolution of the organic salts of formula A and/or B can be carried out at temperatures ranging from 0 to 150 ° C., preferably between 10 and 100° C.

Another subject matter of the present invention is the use of at least one organic salt of formula A and/or B as ionic conductivity additive in the manufacture of an electrode composite material.

In addition, a subject matter of the present invention is Li-ion batteries incorporating said material.

### EXAMPLE 1

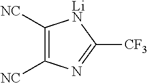

Stirring is carried out using a rotor-stator. 0.0197 g of LiTDI (formula above) is placed in a flask. Dissolution is carried out with 7.08 g of NMP and the solution is left stirring at 25° C. for 10 min. 0.1974 g of PVDF (Kynar®) is added and the mixture is left stirring at 50° C. for 30 min. 0.1982 g of Super P carbon (Timcal®) is subsequently added and the mixture is left stirring for 2 h. Finally, 4.5567 g of LiMn₂O₄ and 2.52 g of NMP are added and the mixture is left stirring for 3 h. The suspension is subsequently spread in the form of a film with a thickness of 100 μm over a sheet of aluminum. The film is allowed to dry at 130° C. for 5 h.

### EXAMPLE 2

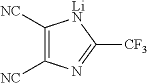

Stirring is carried out using a rotor-stator. 0.0212 g of LiTDI is placed in a flask. Dissolution is carried out with 2.84 g of NMP and the solution is left stirring at 25° C. for 10 min. 0.1063 g of PVDF (Kynar®) is added and the mixture is left stirring at 50° C. for 30 min. 0.1059 g of Super P carbon (Timcal®) is subsequently added and the mixture is left stirring for 2 h. Finally, 4.5580 g of LiNi_{1/3}Mn_{1/3}Co_{1/3}O₂ and 4.52 g of NMP are added and the mixture is left stirring for 3 h. The suspension is spread in the form of a film with a thickness of 250 μm over a sheet of aluminum. The film is left to dry at 130° C. for 8 h.

1. A battery electrode composite material, comprising:
a) at least one electron-conducting additive at a content ranging from 1 to 5% by weight with respect to the total weight of the composite material;
b) a lithium oxide, phosphate, fluorophosphate or silicate as electrode active material capable of reversibly forming an insertion compound with lithium, having an electrochemical potential greater than 2V with respect to the Li/Li⁺ pair;
c) a polymer binder,
d) at least one organic salt of formula A and/or B: 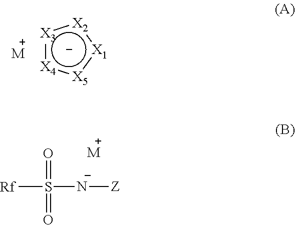
with —Xᵢ— in the formula A independently representing the following groups or atoms: —N═, —N⁻—, —C(R)═, —C⁻(R)—, —O—, —S(═O)(R)═ or —S(R)═ with R representing a group from the group consisting of F, CN, NO₂, S—CN, N═C═S, —OCₙHₘFₚ and —CₙHₘFₚ with n, m and p integers; R_{f} in the formula B representing F, CF₃, CHF₂, CH₂F, C₂HF₄, C₂H₂F₄, C₂H₃F₂, C₂F₅, C₃F₆, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃ and Z representing an electron-withdrawing group chosen from F, CN, SO₂R_{f}, CO₂R_{f} or COR_{f}, and M⁺ representing a lithium, sodium, quaternary or imidazolium cation.

2. The material as claimed in claim 1, wherein the compounds of formula A are imidazolates.

3. The material as claimed in claim 1, wherein the organic salt(s) represents between 0.01 and 10% by weight, with respect to the total weight of the material.

4. The material as claimed in claim 1, wherein the polymer binder is chosen from fluoropolymers, aqueous-based polymers or styrene/butadiene latexes.

5. The material as claimed in claim 1, wherein the electron-conducting additive is chosen from the different allotropic forms of carbon or conducting organic polymers.

6. A process for the preparation of the material as claimed in claim 1, wherein it comprises:
(i) at least a stage of preparation of a suspension involving:
one or more organic salts of formula A and/or B;
an electron-conducting additive;
a polymer binder;
one or more volatile solvents;
an electrode active material chosen from a lithium oxide, phosphate, fluorophosphate or silicate, and
ii) a stage of preparation of a film starting from the suspension prepared in (i).

7. The process as claimed in claim 6, wherein the volatile solvent(s) is or are chosen from organic solvents and water.

8. The process as claimed in claim 7, wherein the organic solvents are chosen from N-methylpyrrolidone or dimethyl sulfoxide.

9. A Li-ion battery comprising the material as claimed in claim 1.

10. The use of at least one salt of formula A and/or B as ionic-conducting additive in the manufacture of an electrode composite material.
